(19) United States
(12) Patent Application Publication
(10) Pub. No.: US 2010/0302059 A1
(43) Pub. Date: Dec. 2, 2010

(54) GRAPHICAL USER INTERFACE AND DEVICE FOR CONTROLLING IT

(76) Inventors: Roman Hnatiuk, Raisio (FI); Francisco Gregorio, Lieto (FI)

Correspondence Address: Pearl Cohen Zedek Latzer, LLP, 1500 Broadway, 12th Floor, New York, NY, 10036, US

(21) Appl. No.: 12/677,972

(22) PCT Filed: Sep. 12, 2008
(86) PCT No.: PCT/FI08/50506

§ 371 Date: Apr. 23, 2010

(30) Foreign Application Priority Data
Sep. 14, 2007 (FI) 20070702

(51) Int. Cl. G08C 19/00; H04N 5/445; G06F 3/048

(52) U.S. Cl. 340/825.72; 348/564; 715/835; 715/823; 715/830; 348/E05.099

(57) ABSTRACT

The display of any home entertainment or consumer electronic product such as a television set is used as a display screen (11) for displaying a graphical user interface (100). The display screen comprises a control unit (13) that receives signals from the remote control device (15) in order to control the graphical user interface (100). The control unit includes software and hardware for providing the user with the graphical user interface by which the user can access various content and services. The control unit (13) comprises at least a controller for controlling operation of the graphical user interface (100), a memory for storing program code in order to implement application feature software to be executed by the control unit, and an interface for receiving and/or transmitting wireless communication between the remote control device and the display screen (11). The memory or dedicated storage medium provides storage (132) of at least a graphic library, user interface objects, managing and editing tools and other such software. In addition the display screen is connected to the local storage medium and/or the external server so that the storage medium is used to download application feature or data over network connection. A system comprising the graphical user interface (100) and the remote control device (15) makes it possible to easily control various functions of the home entertainment and consumer electronic products by simple operations of the remote control device (15) to interact on the display screen (11) in the graphical user interface environment.

### TECHNICAL FIELD OF THE INVENTION

This invention relates to a graphical user interface that is used in home entertainment device environment for easy navigation and content management. This invention also relates to a device for controlling a graphical user interface of that kind being displayed on the display screen.

### BACKGROUND OF THE INVENTION

In a conventional home entertainment and consumer electronic products a remote control device is used to control the operations of the home entertainment equipment, such as a television set, a video recorder, an audio system, an internet terminal, a personal computer and so on. The operations are controlled using text based menus, typically drop down menus, providing information relating to different options of operations.

Microsoft Windows-based user interfaces are also used to realize the user interface functionality of the home entertainment products, as well as some dedicted user interfaces falling between text-based menus and Windows-based menus.

The menu is shown on the display screen of the home entertainment device and selection of the operation function is made by appropriately pressing the selected key of the remote control device. The display unit and the remote control device are provided with transmitting/receiving units that are capable of realizing communication between said unit, i.e. receiving and transmitting control signals.

The conventional remote control devices are used to give basic options of operation, such as selecting channel, adjusting volume/brightness/contrast, changing channel, setting up channel, accessing text-TV, accessing menu, turning power on/off, etc. Options are given by the remote control device through pressing function keys; the user interface, i.e. menus on screen, is mostly used for guiding and informative purposes. The display screen of the consumer electronic device, e.g. a television, receives a control signal from the remote control device and performs the control operations and displays the result on the screen in the graphical user interface environment.

A disadvantage of the conventional user interfaces is that they are rather challenging for the user. The user or installer of the home entertainment devices shall start installation of each device by reading operation manual of that particular device and studying the user interface of that particular device, since each device is typically provided with its own user interface. Operation manuals will be needed often also after installation since the use of various functions of operations is often not intuitive. The text base menus are not intuitive and Windows-based menu functions and structures, i.e. folders, subfolders and files, require a certain level of PC literacy including anti-virus and related knowledge. Conventional remote control devices give options through function keys rather than menus on screen and thus are not driving graphic and/or text enabled interaction.

The problems set forth above are overcome by providing a graphical user interface and a remote control device to interact with a system using simple and easy to use arrangement of icons, navigation among them, and content management in the graphical user interface being displayed on the display screen. This offers a quick way to handle and manage content of various home entertainment and consumer electronic features in a centralized and uniform manner. Product dedicated instruction manuals are made obsolete.

### SUMMARY OF THE INVENTION

It is an objective of the invention to provide a graphical user interface on a display device having easy to use menu structure in a multifeatured environment comprising various home entertainment and consumer electronic features. The menu structure allows to navigate through menu objects on the display screen rather than through function keys of the remote control device. Therefore, the menu structure allows intuitive operation for the user.

It is another objective of the invention to provide a remote control device in order to control a graphical user interface on a display device having easy to use menu structure in a multifeatured environment comprising various home entertainment and consumer electronic features. All the operations of the remote control device can be controlled using a minimum number of control keys, and at the same time allowing more functions and features to be controlled by the remote control device.

It is still another objective of the invention to provide a system comprising at least a graphical user interface and a remote control device in which the remote control device is able to control a graphical user interface on a display device in an easy way in a multifeatured environment comprising various home entertainment and consumer electronic features.

The objectives of the invention are achieved by providing a graphical user interface, a remote control device and a system characterised by what is presented in the characterising parts of the independent claims. Embodiments of the invention are presented in dependent claims.

In accordance with a first aspect of the invention there is provided a graphical user interface for a display screen, said user interface comprising
at least one icon for indicating an application feature,
the icon comprising at least one shelf for indicating content of the application feature, and
the shelf comprising at least one item for indicating content of the shelf, where icons, shelves and items are shown in successive order, wherein
pointing means is configured to indicate the icon in a focus area in order to select the icon,
the pointing means is configured to indicate the shelf in a first direction in relation to the display screen and simultaneously indicate the at least one item of the indicated shelf in order to select the shelf, and
the pointing means is configured to indicate at least one item of the indicated shelf in a second direction in relation to the display screen and simultaneously indicate the indicated item in the focus area within the indicated shelf in order to select the item.

In a preferred embodiment of the invention pointing means is configured to dynamically scroll the icons, the shelves and the items with respect to the focus area.

In another preferred embodiment of the invention further comprises editing tools for editing content of icons, content of shelves and content of items, wherein the editing tools is configured to be displayed on the display screen in a separate frame in a form of a list wherefrom the pointing means is arranged to select a desired editing tool.

Preferably, the user interface is configured to be displayed simultaneously with at least a television picture on the display screen. Together with the television picture also information related to the TV electronic program guide may be displayed.

In accordance with a second aspect of the invention there is provided a remote control device for controlling a graphical user interface on a display screen comprising
indicating means for indicating at least one icon on the graphical user interface,
the indicating means for indicating at least one shelf inside each icon,
the indicating means for indicating at least one item representing content of the shelf, where icons, shelves and items are shown in successive order, wherein
the indicating means is configured to indicate the icon in a focus area in order to select the icon,
the indicating means is configured to indicate the shelf in a first direction with regard to the display screen and simultaneously indicate the at least one item of the indicated shelf in order to select the shelf, and
the indicating means is configured to indicate each item of the indicated shelf in a second direction with regard to the display screen and simultaneously indicate the indicated item in the focus area within the indicated shelf in order to select the item, and
selecting means is configured to select the icon, the shelf and the item being displayed in the focus area on the graphical user interface.

In a preferred embodiment of the invention the indicating means is configured to dynamically indicate the icons to scroll with respect to the focus area.

Preferably, the indicating means is configured to dynamically indicate the shelves to scroll or navigate in the first direction.

Preferably, the indicating means is configured to dynamically indicate the items to scroll or navigate in the second direction.

In another preferred embodiment of the invention a controller is arranged to generate an editing signal in order to active editing tools in a separate frame on the graphical user interface in a form of a list wherefrom the indicating means is arranged to indicate a desired editing tool and the selecting means is arranged to select the desired editing tool.

In accordance with a third aspect of the invention there is provided a system comprising
the graphical user interface as described above,
a display screen comprising a control unit for controlling operation of the graphical user interface on the display screen,
the control unit comprising at least receiving means arranged to receive a control signal for indicating the icon, the shelf and the item and a selection signal in order to activate the icon and the item indicated in the focus area,
the remote control device as described above arranged to transmit the control signal and the selection signal.

A benefit of the embodied invention provides a solution in which it is possible to easily control various functions of the home entertainment and consumer electronic products by simple operations of the remote control device to interact on the display screen in the graphical user interface environment. It is also possible to select a display screen of any product from the plurality of above mentioned products to operate as the display screen in the graphical user interface environment.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

An embodiment of the invention will be described in detail below, by way of example only, with reference to the accompanying drawings, of which

FIG. 1 depicts a block diagram of a system according to an embodiment of the invention,

FIG. 2a depicts an exemplary view of a graphical user interface according to an embodiment of the invention,

FIG. 2b depicts another exemplary view of a graphical user interface according to an embodiment of the invention,

FIG. 3a depicts a front view of a remote control device according to an embodiment of the invention, and

FIG. 3b depicts a block diagram of a remote control device according to an embodiment of the invention.

### DETAILED DESCRIPTION OF THE INVENTION

According to an embodiment of the invention the television set, e.g. TFT, CRT, plasma, projector, etc. is used as a display screen for displaying video data and a graphical user interface. The display screen comprises a control unit that receives control signals from the remote control device or other such input device via radio frequency, infrared, serial, ethernet or other known mode of wireless and wired transmission in order to control the graphical user interface. The control unit includes software and hardware for providing the user with the graphical user interface by which the user can access various content and services. The control unit comprises at least a controller for controlling operation of the graphical user interface, a memory for storing program code in order to implement application feature software to be executed by the control unit, and an interface for receiving and/or transmitting wireless communication between the remote control device and the display screen. The memory or dedicated storage medium also provides storage of at least a graphic library, user interface objects, managing and editing tools and other such software. In addition the display screen is connected to the local storage medium. It can also be connected to the external server so that the storage medium is used to download application feature or data over network connection.

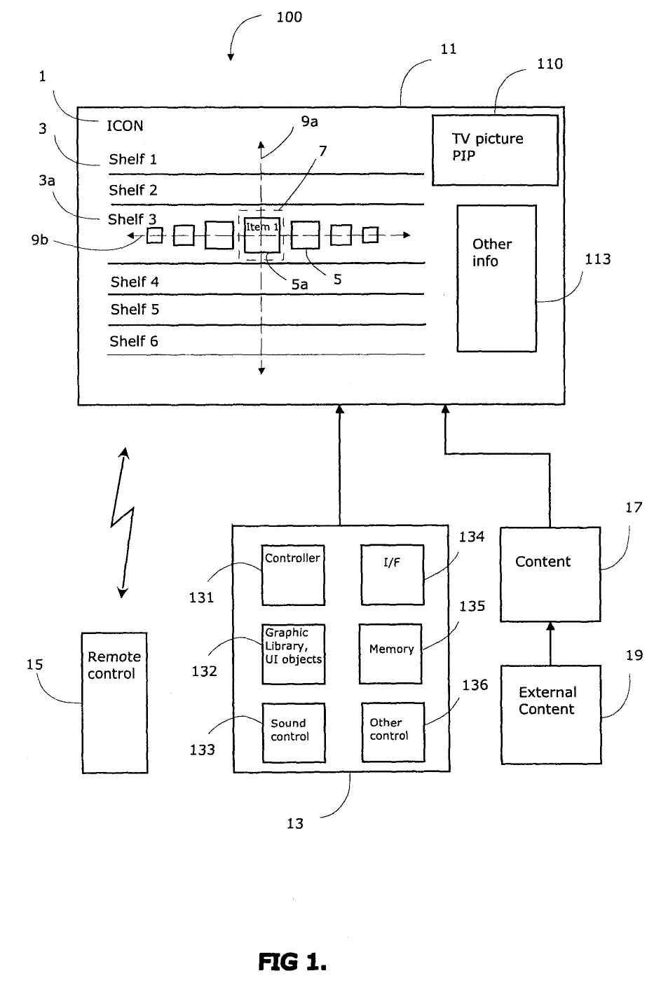

FIG. 1 illustrates a block diagram of a system in accordance with the preferred embodiment of the present invention in which a graphical user interface 100 is displayed on the display screen 11 and is controlled remotely by a remote control device 15. The display screen 11 is a display screen of any home entertainment or consumer electronic device having one, preferably a display screen of the television set. The system further comprises a control unit 13 for controlling the operation of the graphical user interface 100 in accordance with instructions that are given from the remote control device 15. The control unit 13 is connected to the display screen 11 in order to display the graphical user interface 100 and is preferably integrated with the display screen 11. The system further comprises a local storage medium 17 for storing content of different objects that are managed by means of the graphical user interface 100. These objects includes icons 1, shelves 3, and items 5 that form a indication/pointing structure of the graphical user interface, i.e. menu structure, as discussed later in more detail. These objects are also able to refer to external content sources 19, such as Internet/Intranet servers or any other network server or other resource, so that content (services) from external service providers are also available. Such external services include e.g. video on demand (VoD) and web services. Remote servers 19 are connected through conventional network infrastructure, e.g. the Internet, cable, satellite, etc. either wirelessly or wireline.

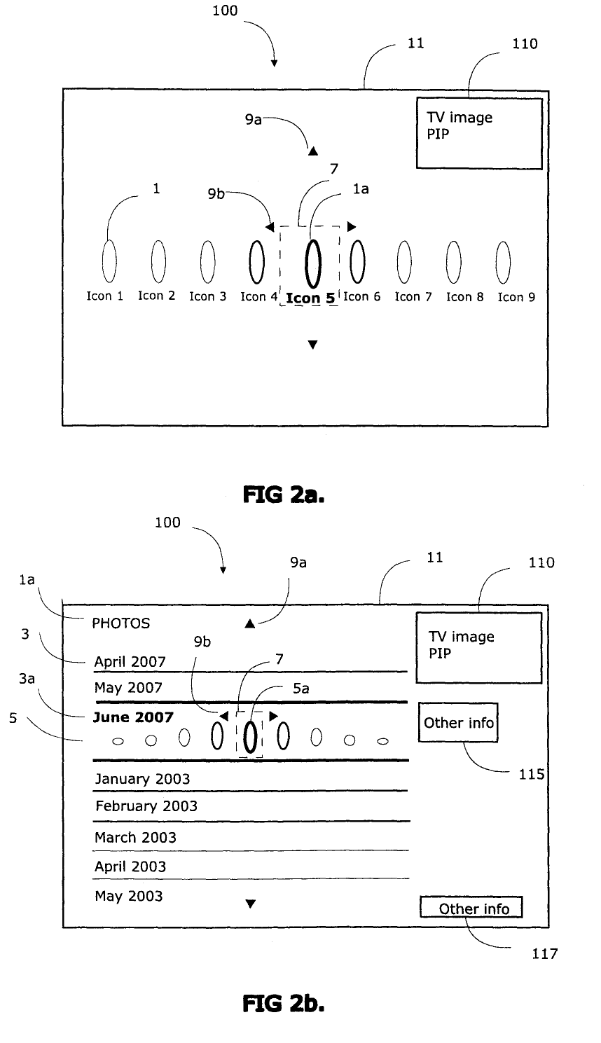

In FIGS. 1, 2a and 2b there is depicted a plurality of frames that are denoted with reference numbers 100, 110, 113, 115, 117 within the display screen 11. As an example, the frame 100 is used to display the graphical user interface 100 according to the invention. The size and/or location of this frame 100 on the display screen 11 is not restricted to any dimensions; the frame 100 can be a full screen size of the display screen 11 or less. In the following both the frame and the graphical user interface displayed on that frame are denoted with the same reference number 100. In this description other frames 110, 113, 115, 117 are called separate frames and they are configured to display other functionality than the visual objects 1, 3, 5 of the graphical user interface and content of the objects 1, 3, 5. The number, size and/or location of the separate frames are not restricted within the display screen 11. The separate frames 110, 113, 115, 117 may also overlap each other or they may overlap the frame 100. An example shown in FIG. 1, following reference numbers are used: a separate frame 110 for displaying TV program, a separate frame 113 for displaying editing tools, an electronic TV program guide, a graphical progress indicator or other such information. Another example shown in FIG. 2b, following reference numbers are used: a separate frame 110 for displaying TV program, a separate frame 113 for displaying editing tools, a separate frame 115 for an electronic TV program guide and a separate frame 117 for a graphical progress indicator. However, any above mentioned functionality can be displayed in any of the separate frames 110, 113, 115, 117 mentioned above.

The control unit 13 of the graphical user interface 100 according to the invention comprises a controller 131 in order to manage the objects on the graphical user interface 100, handle content of the objects and display the objects and their content in accordance with instruction that are given from the remote control device 15. The control unit 13 also comprises interface means 134, e.g. a receiver, in order to receive instructions transmitted from the remote control device 15 and means for conveying instructions between the receiver and the controller 131 as well as between the controller 131 and a plurality of pixels extended over a surface of the display screen 11. The plurality of pixels extended over the surface of display device is arranged to create the visual graphical user interface 100 on the display screen 11 in a known manner. The control unit 13 further comprises a storage 132 for graphical library and user interface objects, etc, to be used within the visual graphical user interface 100 in accordance with instructions that the controller 131 receives from the remote control device 15. Editing tools for editing content of the objects are also stored either in the storage 132 or a memory 135. Upon activation the editing tools they are displayed in the separate frame 113 on the display screen 11. Preferably the editing tools are indicated in a form of a list wherefrom a desired editing tool is selected. As an example, editing tools may comprise following tools: create object, delete object, rename object, start object, sort objects, sort objects by my preferences, etc. Instead of the editing tools the separate frame 113 can be used to display some other information, too. The controller unit 13 also may comprise volume control means 133 for adjusting the volume associated to the graphical user interface 100 in accordance with instructions received from the remote control device 15. Alternatively, a separate volume control means 133 related to the display screen device 11 is arranged. In both cases the volume control means 133 is connected to loudspeakers (not shown) adapted to be used with the screen display device 11. As an option, other control means 136 can be arranged to include the control unit 13, too. A person skilled in the art would appreciate how the controller 131 cooperates with the other elements of the control unit 13 described above.

According to an embodiment of the invention the downloaded content of the activated object may replace entirely the full screen picture of television program. According to another embodiment of the invention the graphical user interface 100 allows the user to view simultaneously a television program and content of the objects displayed on the graphical user interface 100 on the display screen 11. The television program can be displayed in a reduced sized frame 110. Alternatively, the graphical user interface enables also access to content of objects without displaying the television program in a reduced format frame 110. The content of objects is displayed in a frame that is reserved for the visual graphical user interface 100 or in a separate frame 113. For example if Internet content is displayed, it is replacing the content of the screen 11 or it is displayed the separate frame 113. The user is also allowed to switch easily between full screen viewing of television and content of objects. According to some embodiments the downloaded content does not replace the television picture, but is displayed in picture-in-a-picture (PIP) format within the television picture. Alternatively, the television picture is displayed in a frame within a display of the downloaded content. In addition to above information relating to the television programs, e.g. an electronic TV program guide, a graphical progress indicator, etc. can be displayed simultaneously in the separate frame 113.

Each object, i.e. icon 1, shelf 3 and item 5 has its own visual indication on the graphical user interface 100 that designates content of that object. For displaying, handling and content management the visual indication structure of the objects 1, 3, 5 takes place in so called shallow nesting level that is explained later in more detail with reference to FIGS. 2a and 2b. The user can select the visual indication to view the content of the object on the display screen full screen or concurrently with the television program in a reduced sized frame 110. FIG. 1 depicts an exemplary view of the visual graphical user interface 100: When the user actuates a selection on the remote control device 15, pointing means 9a, 9b appears on the display screen indicating a selected shelf 3a and items 5 of that shelf 3a, each item 5 relating to a certain content to be downloadable from content servers 17, 19. In FIG. 1 a selected item 5a is indicated in a focus area 7 and by activating this item 5a from the remote control device 15 the content of that item 5a is downloaded from memory 135 or storage medium 17, 19 and displayed on the display screen 11.

According to all embodiments of the invention the display screen device 11 can be a display device of any home entertainment and consumer product that is equipped with a digital video signal input. According to some embodiments of the invention the display screen 11 can be a display device of any home entertainment and consumer product.

Next along with FIGS. 2a and 2b the menu structure of the graphical user interface 100 according to the invention is discussed in more detail. FIG. 2a depicts one embodiment of the graphical user interface 100 in which icons 1, 1a are displayed as visual indication objects, where each icon 1, 1a is associated to a certain application feature that can be opened and downloaded on the display screen 11 if selected by the user. Icons 1 are the objects of a main menu of the graphical user interface 100 according to the invention. Pointing means 9a, 9b (four arrows in FIGS. 2a and 2b) are arranged to indicate the focus area 7 on the visual graphical user interface 100. The focus area 7 is reserved for indication of the visual object which should be selected and which content should be activated after selection in accordance with instructions from the remote control device 15. As an example, in FIG. 2a □icon 5□ 1a is indicated in the focus area 7. The visual object indicated in the focus area 7 is highlighted, i.e. bolded, maximized in size or otherwise highlighted in a known way. According to one embodiment the invention the focus area 7 is located in the middle of the plurality of the objects, e.g. in the middle of a row of icons as exemplary shown in FIG. 2a. Alternatively, the focus area 7 may be located elsewhere among the plurality of the objects. According to another embodiment of the invention the a first object of the plurality of objects is dynamically indicated in the focus area 7 in the beginning of the indication/selection process, e.g. □icon 1□ is dynamically indicated in the focus area 7 in the beginning of the process instead of □icon 5□ shown in FIG. 2a. The user can predetermine the objects according to his/her preferences so that the first object is the highest one in the ranking list of the objects. The icons 1 of the main menu may exemplary include visual objects for settings, photos, music, video, TV, movies, services, videophone, web, etc.

FIG. 2b illustrates the situation after the icon has been selected in accordance with instructions from the remote control device 15, as explained later. FIG. 2b depicts an embodiment of the graphical user interface 100 in which shelves 3, 3a and items 5, 5a in a selected shelf 3a are displayed as visual indication objects, where each shelf 3, 3a and each item 5, 5a are associated to a certain application feature content that can be downloaded and opened on the display screen 11 if selected by the user. Shelves 3 are the objects of the selected icon 1a of the main menu of the graphical user interface 100 according to the invention and items 5 are the objects of the selected shelf 3a of the menu of the graphical user interface 100 according to the invention. Shelves 3 are indicated and displayed on the display screen 11 one after the other in one direction and items 5, 5a of the selected shelf 3a are indicated and displayed on the display screen 11 one after the other in another direction with respect to shelf 3 indication. Preferably, shelves 3 are indicated and displayed vertically and items 5 of the selected shelf 3a horizontally in accordance with the instruction received from the remote control device 15. Pointing means 9a, 9b are arranged to indicate the shelves 3 in a first direction with regard to the display screen 11 and simultaneously indicate the at least one item 5, 5a of the indicated shelf 3a in order to select the shelf 3a. Then the pointing means 9a, 9b are arranged to indicate each item 5, 5a of the indicated shelf 3a in a second direction with regard to the display screen 11 and simultaneously indicate the indicated item 5a in the focus area 7 of the indicated shelf 3a in order to select the item 5a. Preferably first pointing means 9a is arranged to indicate the shelves 3 in the first direction and second pointing means 9b is arranged to indicate the items 5 in the second direction. The intersection of the first and second pointing means 9a, 9b indicates the focus area 7. As an example, in FIG. 2b in the shelf 3a □June 2007□ under the icon 1a □Photos□ the item 5a is indicated in the focus area 7. As an example, the visual object, here the item 5a, indicated in the focus area 7 is highlighted, i.e. bolded, maximized in size or otherwise highlighted. According to an embodiment the invention the focus area 7 is located in the middle of the plurality of the a row of shelves 3 in the first direction and in the middle of the plurality of the a row of items 5 in the second direction as exemplary shown in FIG. 2b. Alternatively, the focus area 7 may be located elsewhere among the plurality of the objects in both directions. According to another embodiment of the invention the first object of the plurality of objects is dynamically indicated in the focus area 7 in the beginning of the indication/selection process, e.g. in the □shelf 1□ 3 the □item 1□ 5a is dynamically indicated in the focus area 7 in the beginning of the process. The user can predetermine the objects according to his/her preferences so that the first object is the highest one in the ranking list of the objects.

According to one embodiment of the invention the visual object, e.g. the icon 1a in FIG. 2a and the item 5a in FIG. 2b, indicated and displayed in the focus area 7 is highlighted, i.e. bolded, maximized in size or otherwise highlighted in a known way. According to another embodiment of the invention the visual objects 1a, 5a adjacent to the focus area 7 can be less highlighted, e.g. smaller object size, and the visual objects 1a, 5a next to those ones can be still less highlighted, e.g. still smaller size, etc. Therefore, a form and appearance of the visual object 1a, 5a can be made to dynamically depend on its distance from the focus area 7. The further away the visual object 1a, 5a from the focus area 7, the more invisible the visual object 1a, 5a. Alternatively, the visual object, e.g. the icon 1a in FIG. 2a, and the shelf 3a and the item 5a in FIG. 2b, can be indicated and displayed in the focus area 7 without any special highlight effect, e.g. the visual object is indicated by a dot that is shown in the intersection of the pointing means 9a, 9b.

The pointing means 9a, 9b are indicated on the graphical user interface 100 in order to dynamically select the visual objects 1, 3, 5 with respect to the focus area 7 on the display screen 11 in accordance with instructions from the remote control device 15. According to an example shown in FIG. 2a, by indicating and then selecting one of the pointing arrows 9b the icons 1 are scrolling dynamically through the focus area 7 to the direction selected by the arrow. Alternatively, a known navigation key arrangement can be used to select one of the directions of the pointing arrows 9b to dynamically scroll (navigate) the icons 1 through the focus area 7 to the direction selected by the known navigation key arrangement. All available icons 1 may be displayed simultaneously on the display screen 11 in one or more rows of icons 1, or only the icons 1 of the most preferred application features are shown at a time and icons of less favourable application features are hidden. In case of multiple rows of icons 1 (visible or hidden) the direction of the pointing arrows 9a is exploited in a similar way as described in association with the direction of pointing arrows 9b. The same applies when exploiting the known navigation key arrangement.

According to an example shown in FIG. 2b, one of the icons 1, namely □Photos□ 1a, is selected and content of this icon 1a is opened up on the graphical user interface 100. Content of the icon la is indicated in the form of at least one shelf 3 where shelves 3 are displayed in one direction with regard the display screen 11. When one of the shelves 3, namely □June 2007□ 3a, is selected simultaneously at least one item 5 of the selected shelf 3a is displayed in another direction with regard the display screen 11. The indicated shelf 3a is highlighted, i.e. bolded, maximized in size or otherwise highlighted, with regard to other visible shelves 3 on the display screen 11 and the focus area 7 includes in the indicated shelf 3a. The pointing means 9a, 9b are indicated on the graphical user interface 100 in order to dynamically select one of the shelves 3 in the first direction, e.g. vertically, and one of the items 5 in another direction, e.g. horizontally, with respect to the focus area 7 on the display screen 11 in accordance with instructions from the remote control device 15. According to an example shown in FIG. 2b, by indicating and then selecting one of the pointing arrows 9a the shelves 3 are scrolling dynamically through the focus area 7 to the direction selected by the arrow, and the selected shelf 3a □June 2007□ is indicated and displayed highlighted and simultaneously a row of items 4 within the selected shelf 3a □June 2007□ is indicated and displayed and one of the selected items 5a is displayed in the focus area 7 highlighted, as described earlier in connection with icons 1 FIG. 2a. Then by indicating and selecting one of the pointing arrows 9b the items 5 are scrolling dynamically through the focus area 7 to the direction selected by the arrow. Alternatively, a known navigation key arrangement can be used to select one of the directions of the pointing arrows 9a and one of the directions of the pointing arrows 9b to dynamically scroll (navigate) the shelves 3 in one direction and the items 5 through the focus area 7 to the other direction selected by the known navigation key arrangement. All available shelves 3 in one direction and items 5 in the other direction may be displayed simultaneously on the display screen 11 or only the shelves 3 and/or items 5 of the most preferred content by the user are shown at a time and shelves 3 and/or items 5 of less favourable content for the user are hidden. The same applies when exploiting the known navigation key arrangement.

As an example referring to FIGS. 2a and 2b, firstly intersection of the pointing means 9a, 9b is used to indicate the icon 1a □Photos□ displayed in the focus area 7, then pointing means 9a, 9b is used to indicate the shelf 3a □June 2007□ displayed in the focus area 7 and then pointing means 9a, 9b is used to indicate the item 5a □Saturday 25□ displayed in the focus area 7. Then the content of the item 5a □Saturday 25□ can be selected according to instructions from the remote control device 15 and the content is downloaded and opened on the display screen 11, e.g. in a form of a matrix of individual photos taken on Saturday 25 Jun. 2007. Pointing means 9a, 9b is arranged to display an individual photo that is indicated in the focus area 7 as highlighted, i.e. bolded, enlarged, or otherwise highlighted. Editing tools can be also activated and content of the item 5a can be edited.

According to all embodiments of the graphical user interface 100 of the invention the editing tools can be activated and displayed in any of the separate frames 113, 115, 117 when selected in accordance with the instructions received from the remote control device 15. When indicating and selecting any of the objects, i.e. icon 1a, shelf 3a or item 5a, on the display screen 11, content of any of the selected object can be edited by selecting a desired editing tool from the list of editing tools displayed in the separate frame 113, 115, 117.

According to some embodiments of the invention, while the content of the objects 1, 3, 5 is retrieved to the display screen 11, the television signal may be displayed in a separate frame 110, as well as information relating to the television programs, e.g. an electronic program guide, a graphical progress indicator, etc. can be displayed simultaneously in other separate frames 115, 117. The pointing means 9a, 9b is arranged to select the desired editing tool from the list of tools in a known manner.

Although examples referring to FIGS. 1, 2a and 2b are given for the menu structure comprising icons 1, shelves 3 and items 5 as objects, i.e. having a menu depth of 2 levels, which is the preferred depth, the skilled person in the art understands that the depth of the menu structure may contain more levels than 2. E.g. items in one shelf can be seen as □icons□ for 3^{rd} level, etc.

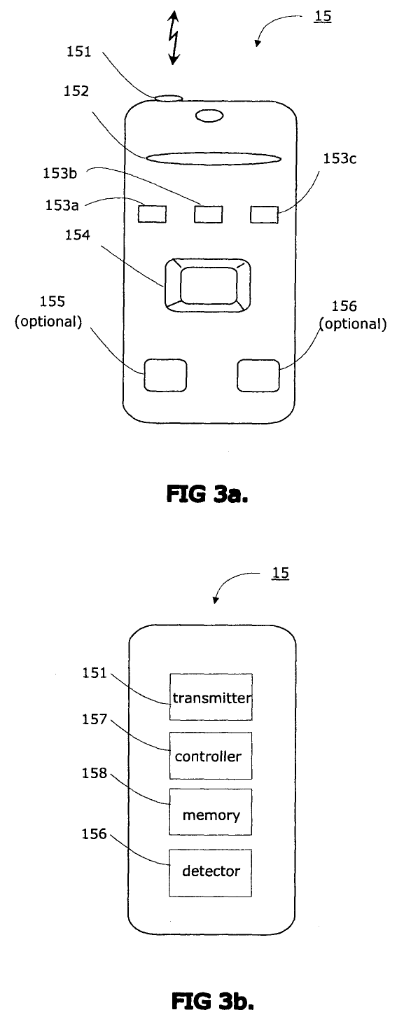

FIG. 3a illustrates an embodiment of the remote control device 15 according to the invention in a front view. The remote control device 15 controls operations of the graphical user interface 100 displayed on the display screen 11 according instructions inputted by the user. The remote control device 15 comprises at least a transmitter 151 for transmitting at least one signal, a navigation key arrangement 154 including OK button for selecting desired navigation position which navigation key arrangement is known as such, a touch sensitive slide 152 for volume control, and a home key 153a, a tool key 153b, and a back key 153c as explained next. In addition, a power key (not shown) for switching the power on/off is needed. Upon selecting the home key 153a it opens up or returns the user to the icon selection page of the graphical user interface 100 (i.e. starting point) and displays the icon selection menu on the display screen 11. The tool key 153b allows quick access to indicate and select the editing tools. The tool key 153b is used to display editing tools in the separate frame 113, 115, 117, and is one example how to implement indicating means configured to indicate a desired editing tool and selecting means configured to select the desired editing tool, as described earlier in the description. The back key 153c is used to return the previous page of the graphical user interface to be displayed on the display screen 11. The page means an instant view of the graphical user interface 100 on the frame 100, and according to instructions from the user the pages are following each other forwards and backwards as the instant views are changing forwards/backwards. Optionally, a set of media control keys 155, e.g. play/pause, stop, record, fast forward, rewind, next chapter, previous chapter, can be arranged for alternatively generating said signals. Optionally, the remote control device 15 comprises a fingerprint recognition unit 156 for identifying the user identity and/or identifying the possible parental lock set-up. The operation of the remote control device 15 is disabled if the fingerprint recognition unit 156 does not identify the user or if parental lock is set up for the identified user. The remote control device 15 comprises indicating means that are used to indicate the visual objects 1, 3, 5 on the graphical user interface 100 in the display screen 11 in accordance of instruction of the user. The indicating means are arranged to interact with the corresponding pointing means 9a, 9b on the graphical user interface 100. The indicating means is arranged to generate a control signal for indicating icons 1, shelves 3 and items 5 on the display screen 11 so that the pointing means 9a, 9b are arranged to receive the control signal and consequently follow instructions produced by the remote control device 15. The control signal is arranged to indicate the visual objects 1, 3, 5 in the focus area 7. Icons 1 can be indicated both in a first and a second directions depending on the case as described earlier. Shelves can be indicated in the first direction, e.g. vertically, and items 5 in the second direction, e.g. horizontally, as described earlier. The control signal is arranged to indicate a selected visual object 1a, 3a, 5a in the focus area 7 in order to select said object. The remote control device 15 further comprises selecting means arranged to generate a selection signal for selecting the object displayed in the focus area 7 in order to activate this object. As an example referring to FIGS. 2a and 2b, first selecting means is used to select the icon 1a □Photos□ indicated in the focus area 7, then selecting means is used to select the shelf 3a □June 2007□ indicated in the focus area 7, then selecting means is used to select the item 5a □Saturday 25□ indicated in the focus area 7 and finally selecting means is used to download and open on the display screen 11 the content of the item □Saturday 25□, e.g. in a form of a matrix of individual photos taken on Saturday 25 Jun. 2007. Indicating means is arranged to display an individual photo that is indicated in the focus area 7 either highlighted, i.e. bolded, enlarged, otherwise highlighted, or not highlighted.

FIG. 3b illustrates a block diagram of an embodiment of the remote control device 15 according to the invention. A transmitter 151 transmits the control signal and selection signal generated by the user by activating the navigation key arrangement 154, e.g. by pressing/touching the key in a desired manner. The tool key 153b is also used to generate an editing signal that opens upon activation the separate frame 113, 115, 117 for editing tools in order to edit content of the objects 1, 3, 5 on the graphical user interface 100. The transmitter 151 transmits the editing signal to the graphical user interface 100. Before transmitting the control, selection and editing signals they are managed and controlled in a controller 157 including the remote controller device. Further the remote control device 15 comprises a memory 158 in order to store features and functions that are required when using fingerprint recognition detector 156 for identifying the user identity and/or identifying the parental lock set-up. Preferably, operation of the biometric fingerprint recognition detector 156 is based on radio frequency transmission. The touch sensitive slide 152 for volume control could be capacity-sensitive and generates a volume signal that the transmitter 151 transmits to the graphical user interface 100.

In a system shown in FIG. 1 the control, selection and editing signals transmitted to the graphical user interface 100 are received by the control unit 13 where the interface 134 includes a receiver in order to receive said signals and the controller 131 in order to handle and manage the functionality to activate by said received signals. Pointing means 9a, 9b on the graphical user interface 100 are controlled at least by the controller 131 and the interface 134. Further the control unit 13 of the display screen 11 comprises a volume control unit 133 arranged to capacitively adjust volume of the speaker (not shown) associated to the graphical user interface 100 in accordance with the volume signal received from the remote control device 15. The transmission of the control, selection, editing and volume signals between the transmitter 151 and the receiver 134 occurs wirelessly using radio frequency signals that are controlled by the controller 157 of the remote control device 15 and the controller 131 of the control unit 13. Alternatively, optical transmission, e.g. infrared transmission, can be used. Indicating means of the remote control device 15 comprises at least the controller 157, the transmitter 151, the navigation key 154 and the home key 153a, the tool key 153b and the back key 153c. Alternatively, indicating means of the remote control device 15 further comprises the fingerprint detector 156 in order to download from the memory 158 user preferences for indication.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is intention, therefore, to be limited only as indicated by scope of the claims appended hereto.

1. A graphical user interface for a display screen, said user interface comprising
at least one icon for indicating an application feature,
the icon comprising at least one shelf for indicating content of the application feature,
the shelf comprising at least one item for indicating content of the shelf, where icons, shelves and items are shown in successive order, and
pointing means, wherein
the pointing means is configured to indicate the icon in a focus area in order to select the icon,
the pointing means is configured to indicate the shelf in a first direction in relation to the display screen and simultaneously indicate the at least one item of the indicated shelf in order to select the shelf, and
the pointing means is configured to indicate at least one item of the indicated shelf in a second direction in relation to the display screen and simultaneously indicate the indicated item in the focus area within the indicated shelf in order to select the item.

2. The graphical user interface according to claim 1, wherein the focus area is in the middle of the shelf.

3. The graphical user interface according to claim 1, wherein the indicated item in the focus area is highlighted.

4. The graphical user interface according to claim 1, wherein the indicated shelf is highlighted with regard to other shelves and the indicated shelf includes the focus area.

5. The graphical user interface according to claim 1, wherein a form of item indication dynamically depends on its distance from the focus area.

6. The graphical user interface according to claim 1, wherein a first item of the shelf is indicated in the focus area when the indicated shelf comprises a plurality of items.

7. The graphical user interface according to claim 1, wherein the pointing means is configured to dynamically scroll the icons with respect to the focus area.

8. The graphical user interface according to claim 1, wherein the pointing means is configured to dynamically scroll or navigate the shelves in the first direction.

9. The graphical user interface according to claim 1, wherein the pointing means is configured to dynamically scroll or navigate the items in the second direction.

10. The graphical user interface according to claim 1, further comprising editing tools for editing content of icons, content of shelves and content of items, wherein the editing tools is configured to be displayed on the display screen in a separate frame in a form of a list wherefrom the pointing means is arranged to select a desired editing tool.

11. The graphical user interface according to claim 1, wherein the user interface is configured to be displayed simultaneously with at least a television picture on the display screen.

12. A remote control device for controlling a graphical user interface on a display screen comprising
indicating means for indicating at least one icon on the graphical user interface,
for indicating at least one shelf inside each icon, and
for indicating at least one item representing content of the shelf, where icons, shelves and items are shown in successive order, wherein
the indicating means is configured to indicate the icon in a focus area in order to select the icon,
the indicating means is configured to indicate the shelf in a first direction in relation to the display screen and simultaneously indicate the at least one item of the indicated shelf in order to select the shelf, and
the indicating means is configured to indicate each item of the indicated shelf in a second direction in relation to the display screen and simultaneously indicate the indicated item in the focus area within the indicated shelf in order to select the item, and
selecting means configured to select the icon, the shelf and the item being displayed in the focus area on the graphical user interface.

13. The device according to claim 12, wherein the indicating means is configured to dynamically indicate the icons to scroll with respect to the focus area.

14. The device according to claim 12, wherein the indicating means is configured to dynamically indicate the shelves to scroll or navigate in the first direction.

15. The device according to claim 12, wherein the indicating means is configured to dynamically indicate the items to scroll or navigate in the second direction.

16. The device according to claim 12, comprising a controller arranged to generate a control signal in order to indicate the icon, the shelf and the item and a selection signal in order to activate the icon, the shelf and the item.

17. The device according to claim 12, wherein a controller is arranged to generate an editing signal in order to active editing tools in a separate frame on the graphical user interface in a form of a list wherefrom the indicating means is arranged to indicate a desired editing tool and the selecting means is arranged to select the desired editing tool.

18. The device according to claim 12, comprising at least a transmitter arranged to transmit the control signal, the selection signal and the editing signal.

19. The device according to claim 12, further comprising a detector for identification recognition in order to start operation of the device.

20. The device according to claim 19, wherein the detector is configured to indicate on the display screen preference objects that are predetermined by the user among available icons, shelves, items and editing tools.

21. The device according to claim 12, further comprising a key member arranged to capacitively adjust sound volume on the graphical user interface.

22. The device according to claim 12, further comprising at least one key member arranged to return a starting page and a previous page of the graphical user interface on the display screen.

23. A system comprising
the graphical user interface according to claim 1,
a display screen comprising a control unit for controlling operation of the graphical user interface on the display screen,
the control unit comprising at least receiving means arranged to receive a control signal for indicating the icon, the shelf and the item and a selection signal in order to activate the icon and the item indicated in the focus area,
the remote control device arranged to transmit the control signal and the selection signal, the remote control device comprising
indicating means for indicating at least one icon on the graphical user interface, for indicating at least one shelf inside each icon, and for indicating at least one item representing content of the shelf, where icons, shelves and items are shown in successive order, and
selecting means configured to select the icon, the shelf and the item being displayed in the focus area on the graphical user interface
wherein
the indicating means is configured to indicate the icon in a focus area in order to select the icon,
the indicating means is configured to indicate the shelf in a first direction in relation to the display screen and simultaneously indicate the at least one item of the indicated shelf in order to select the shelf, and
the indicating means is configured to indicate each item of the indicated shelf in a second direction in relation to the display screen and simultaneously indicate the indicated item in the focus area within the indicated shelf in order to select the item.

24. The system according to claim 23, wherein content of icons, content of shelves and content of items are stored in a local and/or external storage medium.

25. The system according to claim 23, wherein the control unit comprises memory arranged to store at least the editing tools.

26. The system according to claim 23, wherein the control unit comprises memory arranged to store preference objects that are predetermined by the user among available icons, shelves, items and editing tools in order to be activated by the detector of the remote control device.

27. The system according to claim 23, wherein the control unit comprises a sound control member arranged to capacitively adjust sound volume on the graphical user interface.

28. The system according to claim 23, wherein the display screen includes to any home entertainment or consumer electronic device.
